(19) United States
(12) Patent Application Publication
(10) Pub. No.: US 2018/0246739 A1
(43) Pub. Date: Aug. 30, 2018

(54) POSTED INFORMATION PROVIDING DEVICE AND TERMINAL DEVICE

(71) Applicant: Satoshi Ishinada, Osaka (JP)

(72) Inventor: Satoshi Ishinada, Osaka (JP)

(21) Appl. No.: 15/757,597

(22) PCT Filed: Aug. 17, 2016
(86) PCT No.: PCT/JP2016/074014

§ 371 Date: Mar. 5, 2018

(30) Foreign Application Priority Data
Sep. 4, 2015 (JP) 2015-174515

(51) Int. Cl. G06F 9/451; G06F 3/0481; H04L 12/58

(52) U.S. Cl. CPC G06F 9/451; H04L 51/046; H04L 51/16; G06F 3/04817

(57) ABSTRACT

A posted information providing device includes: an image data transmitting unit that transmits, to a first terminal device, image data acquired by a certain terminal device of a plurality of terminal devices, icon position information in which position information on the image data and identification information of an icon are associated with each other, and icon information in which the icon and the position information are associated with each other; a position information receiving unit that receives the identification information of the icon from the first terminal device; a posted information transmitting unit that reads, from a posted information storage unit, icon-related posted information that is posted information related to the identification information of the icon, which is received by the position information receiving unit, and transmits the read-icon related posted information to the first terminal device; and a posted information adding unit that receives new posed information for the icon-related posted information from the first terminal device, and associates the received new posted information with the identification information of the icon, which is received by the position information receiving unit, and causes the posted information storage unit to store the associated new posted information.

### TECHNICAL FIELD

The present invention relates to a posted information providing device and a terminal device, and in particular, relates to a posted information providing device that provides a function of a chat or an electronic bulletin board to a terminal device, and to a terminal device that receives the function.

### BACKGROUND ART

Conventionally, for the purpose of activating communication between users, a posted information management device has been proposed, which causes user terminals to display pieces of posted information posted by users and related to respective positions on a map (for example, refer to Patent Literature 1).

### CITATIONS LIST

### Patent Literature

Patent Literature 1: Japanese Patent Application Laid-Open Publication No. 2012-150742

### SUMMARY OF INVENTION

### Technical Problems

However, according to the conventional posted information management device, an object on which each of the users posts information is the position on the map. Therefore, the content of the posted information is naturally restricted to the content related to places shown on the map, such as information on travel, food, and the like. Moreover, according to the conventional posted information management device, information on a place cannot be posted unless the user actually goes to the place. Therefore, the conventional posted information management device has a problem that versatility is poor, resulting in that it is difficult to activate communication between users.

The present invention has been made in view of such a problem, and it is an object of the present invention to provide a posted information providing device and a terminal device, which are capable of activating the communication between the users in various fields.

### Solutions to Problems

In order to achieve the above object, an aspect of the present invention provides a posted information providing device that is connected to a plurality of terminal devices and provides the plurality of terminal devices with posted information that is information indicating a position on one piece of image data and being posted by at least one terminal device among the plurality of terminal devices, the posted information providing device including: an image data receiving unit that receives the image data from a certain terminal device of the plurality of terminal devices, the image data being acquired by the certain terminal device; an image data storage unit that stores the image data received by the image data receiving unit; an icon position information storage unit that stores icon position information indicating a correspondence relationship between position information indicating a position on the image data stored in the image data storage unit and identification information of an icon superimposed and displayed on the position on the image data, the position being indicated by the position information; an icon storage unit that stores, for each piece of the position information, icon information in which the position information, one icon, and identification information of the one icon are associated with one another; a posted information storage unit that stores the posted information in association with the identification information of the icon; an image data transmitting unit that transmits the image data stored in the image data storage unit, the icon position information stored in the icon position information storage unit, and the icon information stored in the icon storage unit to a first terminal device that is a terminal device permitted to access the posted information providing device among the plurality of terminal devices; a position information receiving unit that receives, from the first terminal device, the identification information of the icon designated by the first terminal device, the icon being superimposed and displayed on the image data based on the image data, the icon position information, and the icon information, which are transmitted by the image data transmitting unit; a posted information transmitting unit that reads, from the posted information storage unit, icon-related posted information that is the posted information displayed on a display screen of the first terminal device and related to the identification information of the icon, the identification information being received by the position information receiving unit, and transmits the read icon-related posted information to the first terminal device; and a posted information adding unit that receives new posted information for the icon-related posted information from the first terminal device, and stores the received new posted information in the posted information storage unit in association with the identification information of the icon, the identification information being received by the position information receiving unit. The position information receiving unit receives position information indicating the position on the image data designated by the first terminal device or identification information of the icon designated by the first terminal device. When receiving the position information, the position information receiving unit further writes the position information into the icon position information storage unit in association with the identification information of a new icon. The position information receiving unit associates a predetermined icon with the position information received by the position information receiving unit and registers the associated icon in the icon storage unit.

Another aspect of the present invention provides a terminal device connected to a posted information providing device that provides posted information posted on a position on one piece of image data, the terminal device including: a user information transmitting unit that transmits user information including an account and a password of a user of the terminal device to the posted information providing device; an image data receiving unit that receives, from the posted information providing device, when the posted information providing device permits an access from the terminal device based on the user information transmitted by the user information transmitting unit, the image data transmitted by a certain terminal device and received by the posted information providing device, icon position information indicating a correspondence relationship between position information indicating the position on the image data and identification information of an icon, and icon information in which the position information, the icon, and the identification information of the icon are associated with one another for each piece of the position information; an image data display control unit that causes a display screen to display the image data in which the icon is superimposed on the position indicated by the position information; a position information transmitting unit that receives an input to designate the icon and transmits the identification information of the designated icon to the posted information providing device; a posted information receiving unit that receives, from the posted information providing device, posted information corresponding to the identification information of the icon, the identification information being transmitted by the position information transmitting unit; a posted information display control unit that causes the display screen to display the posted information received by the posted information receiving unit; and a posted information transmitting unit that receives new posted information for the posted information displayed on the display screen and transmits the received new posted information to the posted information providing device. When the user of the terminal device designates a position on the image data, the position information transmitting unit further transmits position information of the designated position to the posted information providing device, and the posted information providing device that has received the position information transmitted by the position information transmitting unit associates the identification information of a new icon with the position information and associates a predetermined icon with the position information.

It should be noted that the present invention can be realized not only as the posted information providing device or the terminal device, which has such a characteristic processing unit, but also a method in which processing executed by the characteristic processing unit included in the posted information providing device or the terminal device is set as a step. Moreover, the present invention can also be realized as a program for causing a computer to function as the characteristic processing unit included in the posted information providing device or the terminal device. It goes without saying that such a program can be distributed via a computer readable non-transitory recording medium such as a CD-ROM (Compact Disc-Read Only Memory) or a communication network such as the Internet. Moreover, the present invention can also be realized as a semiconductor integrated circuit that realizes a part or all of the posted information providing device or the terminal device, or can also be realized as a system including the posted information providing device or the terminal device.

### Advantageous Effects of Invention

According to the present invention, the communication between the users can be activated in various fields.

### BRIEF DESCRIPTION OF DRAWINGS

FIG. 1 is a diagram showing a configuration of a posted information providing system according to an embodiment of the present invention.

FIG. 2 is a block diagram showing a functional configuration of a terminal device.

FIG. 3 is a diagram showing an example of image data displayed on a display screen of the terminal device.

FIG. 4 is a diagram showing an example of icon-related posted information displayed on the display screen of the terminal device.

FIG. 5 is a block diagram showing a functional configuration of a posted information providing device.

FIG. 6 is a table showing an example of user information stored in a user information storage unit.

FIG. 7 is a table showing an example of icon position information stored in an icon position information storage unit.

FIG. 8 is a table showing an example of icon information stored in an icon storage unit.

FIG. 9 is a table showing an example of the icon-related posted information stored in a posted information storage unit.

FIG. 10 is a table showing an example of image-related posted information stored in the posted information storage unit.

FIG. 11 is a table showing an example of audio data stored in an audio data storage unit.

FIG. 12 is a table showing an example of video data stored in a video data storage unit.

FIG. 13 is a flowchart showing a flow of processing executed by the terminal device.

FIG. 14 is a flowchart showing a flow of processing executed by the posted information providing device.

FIGS. 15(a) to 15(d) are diagrams showing an application example of the terminal device.

FIG. 16 is a diagram for describing an example of pieces of sub image data.

### DESCRIPTION OF EMBODIMENTS

First, embodiments of the present invention will be listed and described.

An embodiment of the present invention provides a posted information providing device that is connected to a plurality of terminal devices and provides the plurality of terminal devices with posted information that is information indicating a position on one piece of image data and being posted by at least one terminal device among the plurality of terminal devices, the posted information providing device including: an image data receiving unit that receives the image data from a certain terminal device of the plurality of terminal devices, the image data being acquired by the certain terminal device; an image data storage unit that stores the image data received by the image data receiving unit; an icon position information storage unit that stores icon position information indicating a correspondence relationship between position information indicating a position on the image data stored in the image data storage unit and identification information of an icon superimposed and displayed on the position on the image data, the position being indicated by the position information; an icon storage unit that stores, for each piece of the position information, icon information in which the position information, one icon, and identification information of the one icon are associated with one another; a posted information storage unit that stores the posted information in association with the identification information of the icon; an image data transmitting unit that transmits the image data stored in the image data storage unit, the icon position information stored in the icon position information storage unit, and the icon information stored in the icon storage unit to a first terminal device that is a terminal device permitted to access the posted information providing device among the plurality of terminal devices; a position information receiving unit that receives, from the first terminal device, the identification information of the icon designated by the first terminal device, the icon being superimposed and displayed on the image data based on the image data, the icon position information, and the icon information, which are transmitted by the image data transmitting unit; a posted information transmitting unit that reads, from the posted information storage unit, icon-related posted information that is the posted information displayed on a display screen of the first terminal device and related to the identification information of the icon, the identification information being received by the position information receiving unit, and transmits the read icon-related posted information to the first terminal device; and a posted information adding unit that receives new posted information for the icon-related posted information from the first terminal device, and stores the received new posted information in the posted information storage unit in association with the identification information of the icon, the identification information being received by the position information receiving unit. The position information receiving unit receives position information indicating the position on the image data designated by the first terminal device or identification information of the icon designated by the first terminal device. When receiving the position information, the position information receiving unit further writes the position information into the icon position information storage unit in association with the identification information of a new icon. The position information receiving unit associates a predetermined icon with the position information received by the position information receiving unit and registers the associated icon in the icon storage unit.

According to this configuration, the image data acquired by the certain terminal device of the terminal devices, the icon position information indicating the correspondence relationship between the position information indicating the position on the image data and the identification information of the icon, and the icon information in which the position information and the icon are associated with each other are transmitted to the first terminal device. Therefore, in the first terminal device, the image data acquired by the certain terminal device of the terminal devices can be displayed, and in addition, the icon can be displayed on the image data. Moreover, upon receiving the identification information of the icon from the first terminal device, the icon-related posted information related to the identification information is transmitted to the first terminal device. That is, when the user of the first terminal device designates the icon on the image data by a tap operation or the like, the icon-related posted information corresponding to the identification information of the designated icon is transmitted to the first terminal device. In the first terminal device, the icon-related posted information can be displayed. Upon receiving new posted information, which is input by the user for the icon-related posted information, from the first terminal device, the posted information providing device can cause the posted information storage unit to store the new posted information. In this way, the posted information providing device can store the posted information in association with the identification information of the icon on the image data acquired by the certain terminal device of the terminal devices, and can provide the posted information to the terminal device. Moreover, when receiving new posted information from the first terminal device, the posted information providing device can store the new posted information in association with the identification information of the icon. Therefore, the user of the first terminal device can post information to the position indicated by the icon in the image data. In this way, the object for which the user is to post information is not limited to a map, and the user can post information to any image. Moreover, only by designating the icon on the image data, the first terminal device can receive the posted information related to the identification information of the icon or can post new information. In other words, without actually going to such a place where the image data is acquired, the user of the first terminal device can post information indicating the place. In this way, a function of an electronic bulletin board or chat can be provided for each position on the image data. As a result, the communication between the users can be activated in various fields.

Moreover, when the user of the first terminal device designates the position, at which no icon is disposed on the image data, by a tap operation or the like, the position information indicating the position is transmitted to the posted information providing device. With this operation, the position information of the position designated by the user is associated with the identification information of the icon, and is written as icon position information into the icon position information storage unit. The icon position information is written into the icon position information storage unit, whereby the icon information in which the icon is associated with the position information is also stored in the icon storage unit. In subsequent processing, the icon position information and the icon information are transmitted to the first terminal device, whereby the user of the first terminal device can post new posted information corresponding to the identification information of the icon.

The image data may be image data captured by the certain terminal device of the plurality of terminal devices.

According to this configuration, the user can post information indicating an arbitrary position on the image data captured by the user. For example, for the image data on which images of a plurality of objects are captured, if an icon associated with one of the objects is designated by a tap operation, then information on the object can be posted.

Moreover, the posted information providing device mentioned above may further include: an audio data storage unit that stores audio data in association with the identification information of the icon; and an audio data transmitting unit that reads, from the audio data storage unit, the audio data related to the identification information of the icon, the identification information being received by the position information receiving unit, and transmits the read audio data to the first terminal device.

According to this configuration, for example, when the user of the first terminal device designates the icon by a tap operation or the like, the audio data can be output from the first terminal device. For example, in order to issue an audio instruction to each of security guards located at a concert venue, an icon is disposed on the image data showing a guide map of the concert venue, and audio data corresponding to the icon is transmitted to the first terminal device. As a result, when the security guard who uses the first terminal device designates such an icon corresponding to the position, at which the security guard him/herself is located, by a tap operation or the like, the security guard can be notified of an instruction by an audio message.

Moreover, the posted information providing device mentioned above may further include: a video data storage unit that stores video data in association with the identification information of the icon; and a video data transmitting unit that reads, from the video data storage unit, the video data related to the identification information of the icon, the identification information being received by the position information receiving unit, and transmits the read video data to the first terminal device.

According to this configuration, for example, when the user of the first terminal device designates the icon by a tap operation or the like, the video data can be output from the first terminal device. Therefore, for example, by a video, each user can be notified of an instruction or the like, which is difficult to convey in a sentence.

Moreover, the icon stored in the icon storage unit may have different display modes for each piece of position information.

According to this configuration, the display mode of the icon can be changed for each position. For example, in the image data obtained by capturing images of a plurality of objects, icons different for each object can be disposed. A certain icon is displayed in such a display mode of being prominent in comparison with other icons, whereby the user can be urged to browse posted information of the certain icon.

Moreover, the post information storage unit may further store posted information in association with the image data, the posted information transmitting unit may further read, from the posted information storage unit, image-related posted information that is the posted information related to the image data, and may transmit the read image-related posted information to the first terminal device, and the posted information adding unit may further receive new posted information for the image-related posted information from the first terminal device, may associate the received new posted information with the image data, and may cause the posted information storage unit to store the associated new posted information.

According to this configuration, the posted information can be posted not only on the icon on the image data but also on the entire image data. As a result, such a function of an electronic bulletin board or chat for exchanging information can be provided to the entire image data. Therefore, the communication between the users can be activated in various fields.

Moreover, the image data may be obtained by joining a plurality of pieces of sub image data to one another, the image data storage unit may store, as the image data, the plurality of pieces of sub image data obtained by dividing the image data, and the image data transmitting unit may transmit, to the first terminal device, the plurality of pieces of sub image data stored in the image data storage unit as the image data stored in the image data storage unit.

According to this configuration, the user can post the information also on the image data obtained by joining the plurality of pieces of sub image data.

Another embodiment of the present invention provides a terminal device connected to a posted information providing device that provides posted information posted on a position on one piece of image data, the terminal device including: a user information transmitting unit that transmits user information including an account and a password of a user of the terminal device to the posted information providing device; an image data receiving unit that receives, from the posted information providing device, when the posted information providing device permits an access from the terminal device based on the user information transmitted by the user information transmitting unit, the image data transmitted by a certain terminal device and received by the posted information providing device, icon position information indicating a correspondence relationship between position information indicating the position on the image data and identification information of an icon, and icon information in which the position information, the icon, and the identification information of the icon are associated with one another for each piece of the position information; an image data display control unit that causes a display screen to display the image data in which the icon is superimposed on the position indicated by the position information; a position information transmitting unit that receives an input to designate the icon and transmits the identification information of the designated icon to the posted information providing device; a posted information receiving unit that receives, from the posted information providing device, posted information corresponding to the identification information of the icon, the identification information being transmitted by the position information transmitting unit; a posted information display control unit that causes the display screen to display the posted information received by the posted information receiving unit; and a posted information transmitting unit that receives new posted information for the posted information displayed on the display screen and transmits the received new posted information to the posted information providing device. When the user of the terminal device designates a position on the image data, the position information transmitting unit further transmits position information of the designated position to the posted information providing device, and the posted information providing device that has received the position information transmitted by the position information transmitting unit associates the identification information of a new icon with the position information and associates a predetermined icon with the position information.

According to this configuration, the image data on which the icon is superimposed is displayed on the display screen. It should be noted that the image data is acquired by a certain terminal device of the terminal devices. When the user of the terminal device designates the icon on the image data by a tap operation or the like, the posted information corresponding to the identification information of the designated icon can be received, and the posted information can be displayed on the display screen. Moreover, the user can transmit new posted information for the posted information to the posted information providing device. In this way, the user can post information on the position only by designating the position on the image data. The object for which the user is to post information is not limited to a map, and the user can post information to any image. Moreover, without actually going to such a place where the image data is acquired, the user of the terminal device can post information on the place only by designating the icon. In this way, the function of an electronic bulletin board or chat can be provided for each position on the image data. As a result, the communication between the users can be activated in various fields.

Moreover, when the user of the terminal device designates the position, at which no icon is disposed on the image data, by a tap operation or the like, the position information indicating the position is transmitted to the posted information providing device. With this operation, the position information of the position designated by the user is associated with the identification information of the icon by the posted information providing device. By subsequent processing, the icon position information and the icon information are transmitted from the posted information providing device to the terminal device, and accordingly, the terminal device can display the icon at the position indicated by the icon position information. The user designates the icon by a tap operation or the like, thus making it possible to newly post posted information.

Moreover, the terminal device mentioned above may further include: an audio data receiving unit that receives, from the posted information providing device, audio data related to the identification information of the icon, the identification information being transmitted from the position information transmitting unit; and an audio data output unit that outputs the audio data received by the audio data receiving unit.

According to this configuration, for example, when the user of the terminal device designates the icon by a tap operation or the like, the audio data can be output from the terminal device. For example, in order to issue an audio instruction to each of security guards located at a concert venue, an icon is disposed on the image data showing a guide map of the concert venue, and audio data corresponding to the icon is received. As a result, when the security guard who uses the terminal device designates such an icon corresponding to the position, at which the security guard him/herself is located, by a tap operation or the like, the security guard can be notified of an instruction by an audio message.

Moreover, the image data receiving unit may receive, as the image data received by the posted information providing device, a plurality of pieces of sub image data obtained by dividing the image data, and the image data display control unit may create the image data by joining the plurality of pieces of sub image data to one another and may cause the display screen to display the image data in which the icon is superimposed at a position indicated by the position information.

According to this configuration, the user can post the information also on the image data obtained by joining the plurality of pieces of sub image data.

### [Details of Embodiments of Invention of Present Application]

Hereinafter, embodiments of the present invention will be described in detail with reference to the drawings. The embodiments described below each show one preferable specific example of the present invention. Numerical values, shapes, constituent elements, arrangement positions and connection modes of the constituent elements, steps, order of the steps, and the like, which are shown in the following embodiments, are merely examples and are not intended to limit the present invention. The invention is specified by the claims. Therefore, among the constituent elements in the following embodiments, constituent elements which are not described in the independent claims showing the top level concept of the present invention are not necessarily required to achieve the object of the present invention, but will be described as constituting a more preferred form.

### [1. Overall Configuration of System]

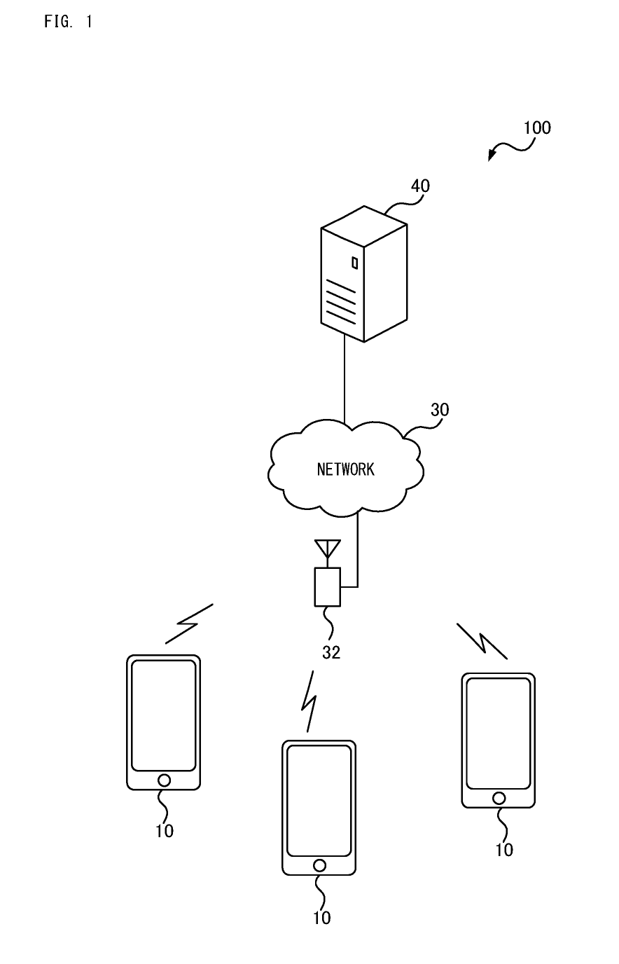

FIG. 1 is a diagram showing a configuration of a posted information providing system according to an embodiment of the present invention.

A posted information providing system 100 includes a posted information providing device 40 and a plurality of terminal devices 10. The terminal devices 10 are connected to the posted information providing device 40 via a radio base station 32 and a network 30 such as the Internet and a mobile phone line.

The posted information providing system 100 is a system in which the posted information providing device 40 manages posted information posted by the plurality of terminal devices 10, and the posted information is provided to the plurality of terminal devices 10.

### [2. Configuration of Terminal Device 10]

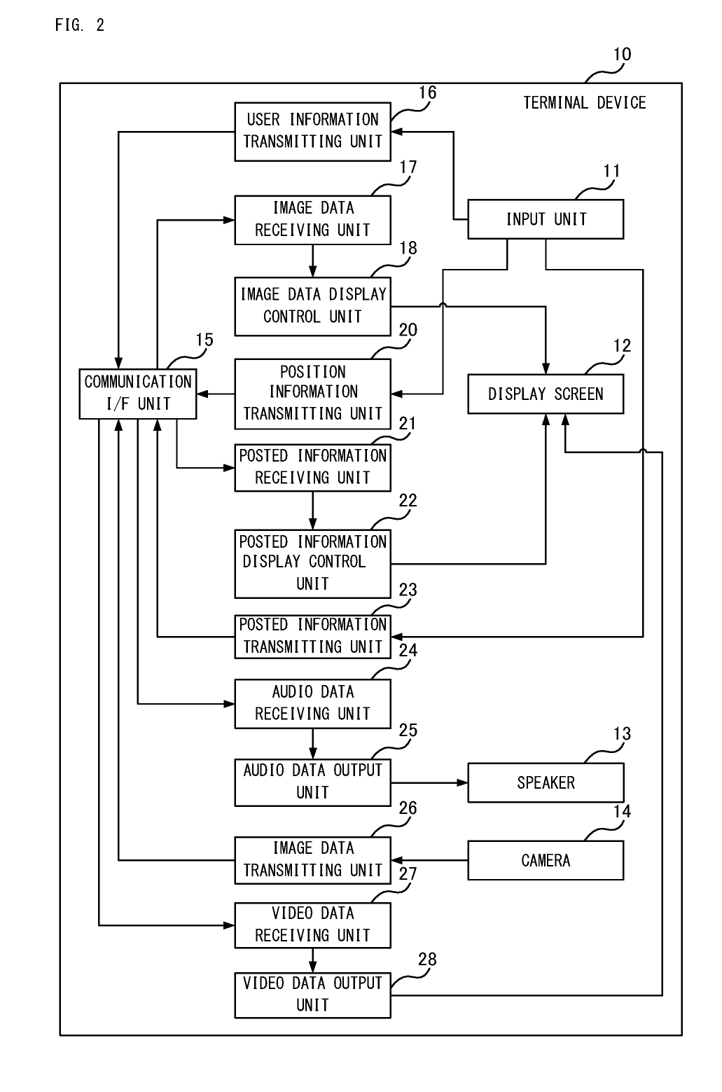

FIG. 2 is a block diagram showing a functional configuration of each of the terminal devices 10. The terminal device 10 includes a computer, a tablet terminal, a smartphone, or the like, which includes a CPU (Central Processing Unit), RAM (Random Access Memory), ROM (Read Only Memory), and the like.

The terminal device 10 includes an input unit 11, a display screen 12, a speaker 13, a camera 14, a communication I/F unit 15, a user information transmitting unit 16, an image data receiving unit 17, an image data display control unit 18, a position information transmitting unit 20, a posted information receiving unit 21, a posted information display control unit 22, a posted information transmitting unit 23, an audio data receiving unit 24, an audio data output unit 25, an image data transmitting unit 26, a video data receiving unit 27, and a video data output unit 28.

The input unit 11 is a processing unit for inputting information to the terminal device 10, and includes a hardware keyboard, a software keyboard, a touch panel, a mouse, and the like.

The display screen 12 is a display screen for displaying images and characters, and includes a monitor, a display, or the like.

The speaker 13 outputs a sound to a user of the terminal device 10.

The camera 14 captures an image of an object and outputs image data thereof to the image data transmitting unit 26.

The communication I/F (interface) unit 15 is a communication interface for performing data communication with the posted information providing device 40 via the radio base station 32 and the network 30, and includes a wireless communication module or the like.

The user information transmitting unit 16 acquires user information, which includes an account and a password entered by the user using the input unit 11, from the input unit 11, and transmits the acquired user information to the posted information providing device 40 via the communication I/F unit 15.

The image data receiving unit 17 receives image data via the communication I/F unit 15. The image data is image data acquired by a certain terminal device of the terminal devices 10, and is, for example, image data captured by a certain terminal device of the terminal devices 10. The image data receiving unit 17 further receives icon position information indicating a correspondence relationship between position information on the image data and identification information of an icon, and receives icon information in which the icon is associated with the position information. By operating the input unit 11, the user can also add a diagram on the image received by the image data receiving unit 17. Moreover, the user can also change a line color of the diagram.

The image data display control unit 18 receives, from the image data receiving unit 17, the image data, the icon position information, and the icon information, and causes the display screen 12 to display the image data in which the icon is superimposed on the position indicated by the position information included in the icon position information.

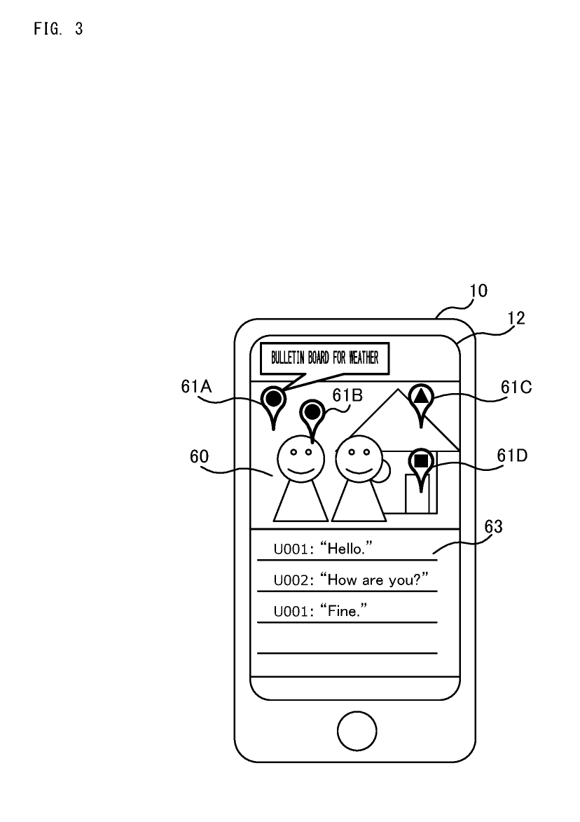

FIG. 3 is a diagram showing an example of the image data displayed on the display screen 12 of the terminal device 10. On the display screen 12, image data 60 including two persons and a house is displayed. Moreover, icons 61A to 61D are superimposed on the image data 60.

The position information transmitting unit 20 receives identification information of an icon from the input unit 11, the icon being superimposed on the image data displayed on the display screen 12 and being designated by the user operating the input unit 11. For example, it is assumed that the user designates an icon 61B by tapping the icon 61B on the display screen 12 shown in FIG. 3. It is assumed that the display screen 12 has a function of a touch panel (input unit 11). Then, the position information transmitting unit 20 receives position information of the icon 61B from the input unit 11. For example, the position information transmitting unit 20 receives position information, which indicates a position of a lowest end in a region of the icon 61B, as the position information of the icon 61B. Based on the icon position information mentioned above, the position information transmitting unit 20 obtains an icon ID, which is identification information of the icon, from the received position information of the icon (here, icon 61B), and transmits the icon ID via the communication I/F unit 15 to the posted information providing device 40.

It should be noted that, when the user operates the input unit 11 to designate a position other than the icon on the image data, the position information transmitting unit 20 transmits position information of the designated position to the posted information providing device 40. Moreover, when the user operates the input unit 11 to perform a drag operation or a swipe operation on the image data, the position information transmitting unit 20 transmits position information of a dragged or swiped position (hereinafter referred to as “diagram information”) to the posted information providing device 40.

The posted information receiving unit 21 receives icon-related posted information, which is posted information corresponding to the icon ID transmitted by the position information transmitting unit 20, from the posted information providing device 40 via the communication I/F unit 15.

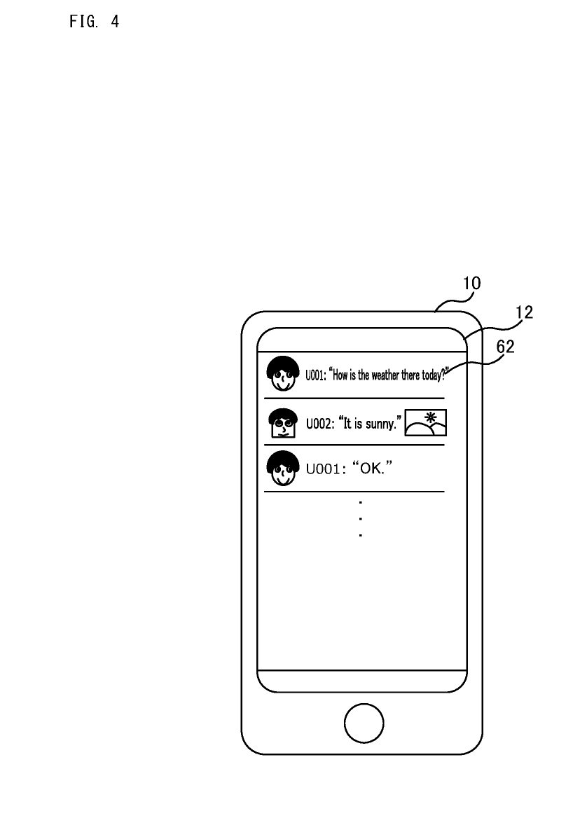

The posted information display control unit 22 performs control to display the icon-related posted information, which is received by the posted information receiving unit 21, on the display screen 12. For example, as shown in FIG. 4, the posted information display control unit 22 performs control to display icon-related posted information 62 on the display screen 12. The icon-related posted information 62 indicates a conversation exchanged between a user “U001” and a user “U002”.

The posted information transmitting unit 23 receives new posted information for the posted information, which is displayed on the display screen 12, from the input unit 11, and transmits the received new posted information to the posted information providing device 40 via the communication I/F unit 15. For example, when the user operates the input unit 11 to input new posted information for the icon-related posted information 62 shown in FIG. 4, the posted information transmitting unit 23 receives the input new posted information from the input unit 11, and transmits the received new posted information to the posted information providing device 40 via the communication I/F unit 15.

The audio data receiving unit 24 receives audio data related to the icon ID transmitted by the position information transmitting unit 20. For example, when the position information transmitting unit 20 transmits the icon ID of the icon 61B to the posted information providing device 40 by the user tapping the icon 61B, the audio data receiving unit 24 receives audio data, which is associated with the icon ID of the icon 61B, from the posted information providing device 40.

The audio data output unit 25 outputs the audio data, which is received by the audio data receiving unit 24, from the speaker 13.

The image data transmitting unit 26 transmits image data, which is obtained by the camera 14 capturing an image of the object, to the posted information providing device 40 via the communication I/F unit 15.

The video data receiving unit 27 receives video data related to the icon ID transmitted by the position information transmitting unit 20. For example, when the position information transmitting unit 20 transmits the icon ID of the icon 61B to the posted information providing device 40 by the user tapping the icon 61B, the video data receiving unit 27 receives video data, which is associated with the icon ID of the icon 61B, from the posted information providing device 40.

The video data output unit 28 displays the video data, which is received by the video data receiving unit 27, on the display screen 12. For example, a balloon is provided near the icon 61B, and the video data is displayed in the balloon.

### [3. Configuration of Posted Information Providing Device 40]

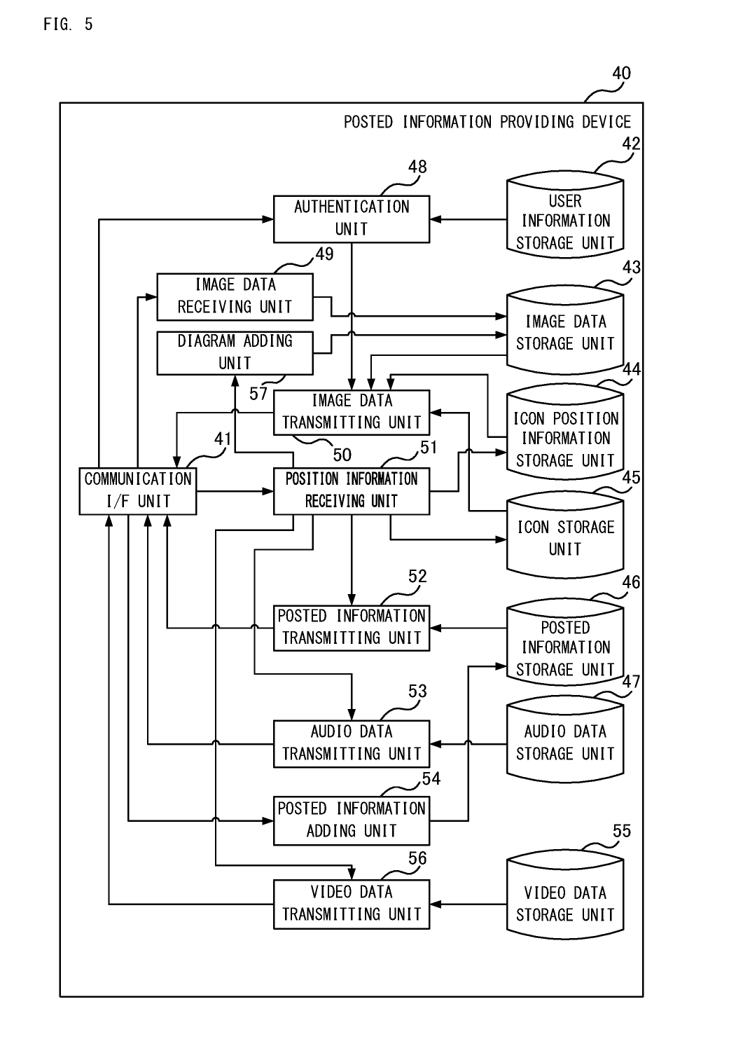

FIG. 5 is a block diagram showing a functional configuration of the posted information providing device 40. The posted information providing device 40 includes a computer or the like, which includes a CPU, a RAM, a ROM, and the like.

The posted information providing device 40 includes a communication I/F unit 41, a user information storage unit 42, an image data storage unit 43, an icon position information storage unit 44, an icon storage unit 45, a posted information storage unit 46, an audio data storage unit 47, an authentication unit 48, an image data receiving unit 49, an image data transmitting unit 50, a position information receiving unit 51, a posted information transmitting unit 52, an audio data transmitting unit 53, a posted information adding unit 54, a video data storage unit 55, a video data transmitting unit 56, and a diagram adding unit 57.

The communication I/F unit 41 is a communication interface for performing data communication with the terminal devices 10 via the network 30 and the radio base station 32, and includes a radio communication module, a wired communication module, or the like.

The user information storage unit 42 is a storage device that stores user information on users permitted to use the posted information providing device 40, and includes an HDD (Hard Disk Drive) or the like.

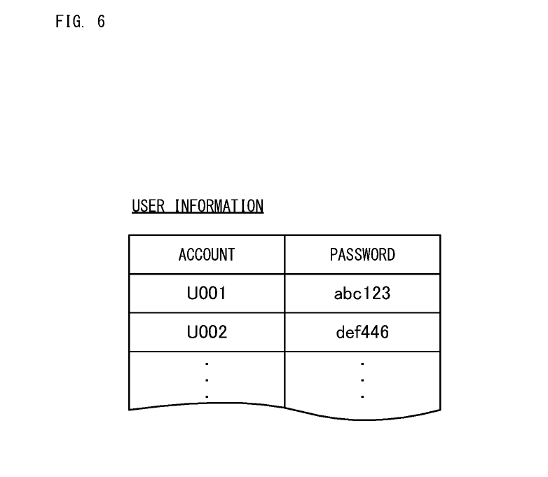

FIG. 6 is a diagram showing an example of the user information stored in the user information storage unit 42, and the user information includes sets of accounts and passwords of the users. The user information is provided for each of the users. For example, user information of a certain user is indicated by a combination of an account “U001” and a password “abc 123”. It should be noted that the account may be a character string set by the user or an administrator, or may be a mail address, a terminal ID of the terminal device 10, or the like.

The image data storage unit 43 is a storage device that stores image data acquired by a certain terminal device of the plurality of terminal devices 10, and includes an HDD or the like. For example, the image data storage unit 43 stores the image data 60 as shown in FIG. 3.

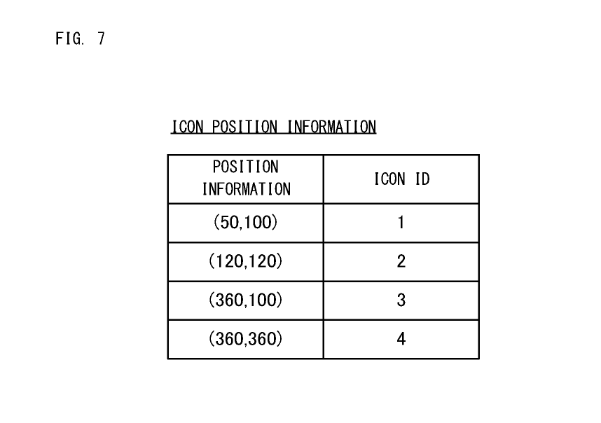

The icon position information storage unit 44 is a storage device that stores icon position information in which the position on the image data, which is stored in the image data storage unit 43, that is, the position information indicating the position of the icon is associated with the identification information of the icon, and includes an HDD or the like. FIG. 7 is a diagram showing an example of the icon position information stored in the icon position information storage unit 44. Position coordinates and icon IDs of the icons 61A, 61B, 61C and 61D on the image data 60 shown in FIG. 3 are shown in order from the top.

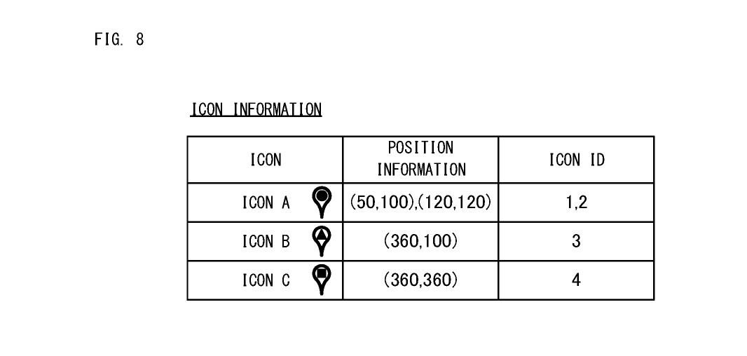

The icon storage unit 45 is a storage device that stores the icon information. That is, the icon storage unit 45 stores the icon information in which icons (image data of the icons) are associated with pieces of position information indicating positions of the icons, and includes an HDD or the like. FIG. 8 is a table showing an example of the icon information stored in the icon storage unit 45. An icon A shows the icons 61A and 61B in FIG. 3, an icon B shows the icon 61C in FIG. 3, and an icon C shows the icon 61D in FIG. 3. The pieces of position information of the icons 61A and 61B and icon IDs “1” and “2” are associated with the icon A, the position information of the icon 61C and an icon ID “3” are associated with the icon B, and the position information of the icon 61D and an icon ID “4” are associated with the icon C.

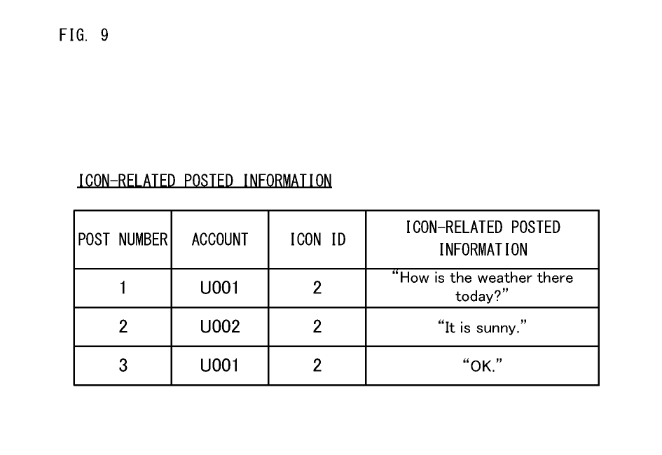

The posted information storage unit 46 is a storage device that stores posted information (“icon-related posted information” mentioned above) in association with the icon IDs, and includes an HDD or the like. FIG. 9 is a table showing an example of the icon-related posted information stored in the posted information storage unit 46. The posted information storage unit 46 stores post numbers, the accounts of the users who posted the icon-related posted information, the icon IDs, and content of the icon-related posted information. As shown in FIG. 4, the icon-related posted information is the same as the content of the icon-related posted information 62 displayed on the display screen 12.

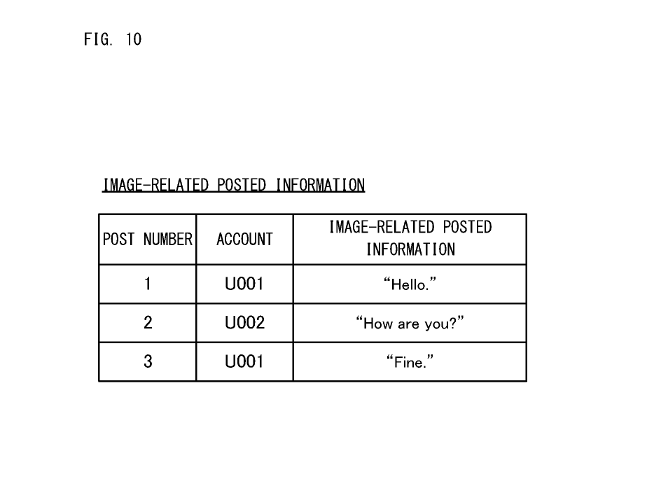

The posted information storage unit 46 further stores the posted information in association with the image data stored in the image data storage unit 43. The posted information associated with the image data is hereinafter referred to as “image-related posted information”. FIG. 10 is a table showing an example of the image-related posted information stored in the posted information storage unit 46. The posted information storage unit 46 stores the post numbers, the accounts of the users who posted the image-related posted information, and content of the image-related posted information. For example, a field of the post number “1” indicates that the image-related posted information posted by the user of the account “U001” is “Hello”. It should be noted that, when there are a plurality of pieces of image data, the posted information storage unit 46 stores the image-related posted information for each of the pieces of image data.

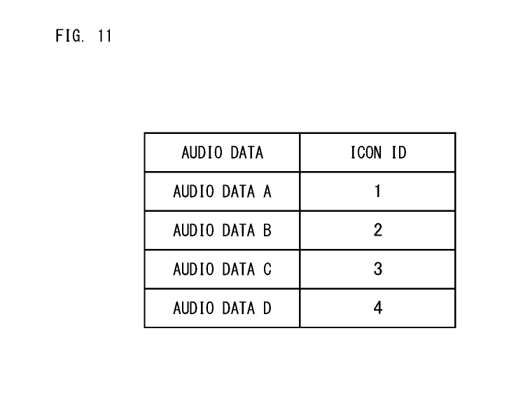

The audio data storage unit 47 stores pieces of audio data in association with the icon IDs. FIG. 11 is a table showing an example of the audio data stored in the audio data storage unit 47. Pieces of audio data A to D are stored in the audio data storage unit 47. The icon ID “1” of the icon 61A in FIG. 3 is associated with the audio data A, the icon ID “2” of the icon 61B in FIG. 3 is associated with the audio data B, the icon ID “3” of the icon 61C in FIG. 3 is associated with the audio data C, and the icon ID “4” of the icon 61D in FIG. 3 is associated with the audio data D.

The authentication unit 48 acquires the user information from each of the terminal devices 10 via the communication I/F unit 41, and determines whether or not the acquired user information is registered in the user information storage unit 42, thereby determining whether or not to authenticate a user's access.

The image data receiving unit 49 receives the image data, which is acquired by the terminal device 10, that is, captured by the terminal device 10, via the communication I/F unit 41 from the terminal device 10, and writes the received image data to the image data storage unit 43.

To the terminal device 10 requesting browsing of the posted information, the image data transmitting unit 50 transmits the image data stored in the image data storage unit 43, the icon position information stored in the icon position information storage unit 44, and the icon information stored in the icon storage unit 45.

From the terminal device 10 requesting the browsing of the posted information, the position information receiving unit 51 receives the icon ID of the icon on the image data, which is designated by the terminal device 10. For example, from the terminal device 10, the position information receiving unit 51 receives the icon ID of the icon designated by the user tapping the display screen 12 of the terminal device 10.

It should be noted that, from the terminal device 10, the position information receiving unit 51 may receive not the icon ID but position information indicating a position other than the icon on the image data. When the position information receiving unit 51 receives the position information indicating the position other than the icon on the image data, the position information receiving unit 51 registers icon position information in which the received position information is associated with a new icon ID, in the icon position information storage unit 44. Moreover, the position information receiving unit 51 registers icon information in which the icon is associated with the received position information, in the icon storage unit 45. The icon registered in the icon storage unit 45 is a predetermined icon. As a result, such new icon position information and icon information are registered.

Moreover, from the terminal device 10, the position information receiving unit 51 may receive position information (diagram information) of a position dragged or swiped on the image data. The diagram information is used by the diagram adding unit 57 to be described later.

The posted information transmitting unit 52 reads the icon-related posted information, which is posted information related to the icon ID received by the position information receiving unit 51, from the posted information storage unit 46, and transmits the read icon-related posted information to the terminal device 10 requesting the browsing of the posted information.

The audio data transmitting unit 53 reads audio data, which is related to the icon ID received by the position information receiving unit 51, from the audio data storage unit 47, and transmits the read audio data to the terminal device 10 requesting the browsing of the posted information.

The posted information adding unit 54 receives new posted information for the icon-related posted information from the terminal device 10 requesting the browsing of the posted information, associates the received new posted information with the icon ID received by the position information receiving unit 51, and causes the posted information storage unit 46 to store the new posted information associated with the icon ID. As a result, such new posted information is added to the icon-related posted information related to the icon designated by the user.

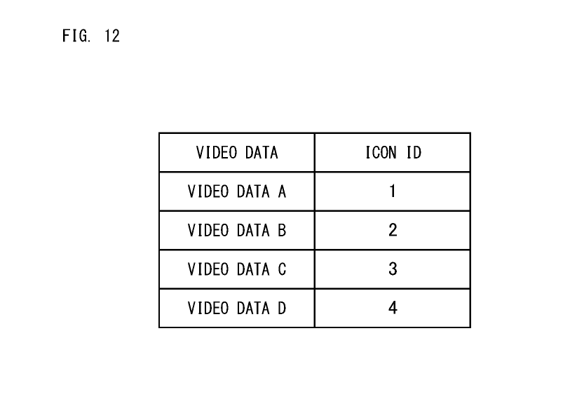

The video data storage unit 55 stores pieces of video data in association with the icon IDs. FIG. 12 is a table showing an example of the video data stored in the video data storage unit 55. Pieces of video data A to D are stored in the video data storage unit 55. The icon ID “1” of the icon 61A in FIG. 3 is associated with the video data A, the icon ID “2” of the icon 61B in FIG. 3 is associated with the video data B, the icon ID “3” of the icon 61C in FIG. 3 is associated with the video data C, and the icon ID “4” of the icon 61D in FIG. 3 is associated with the video data D.

The video data transmitting unit 56 reads video data, which is related to the icon ID received by the position information receiving unit 51, from the video data storage unit 55, and transmits the read video data to the terminal device 10 requesting the browsing of the posted information.

When the position information receiving unit 51 receives the diagram information, the diagram adding unit 57 writes a diagram on the image data stored in the image data storage unit 43 according to the position information, and updates the image data storage unit 43. It should be noted that a color and a thickness of the diagram are changeable by designation from the terminal device 10.

### [4. Processing Flow of Terminal Device 10]

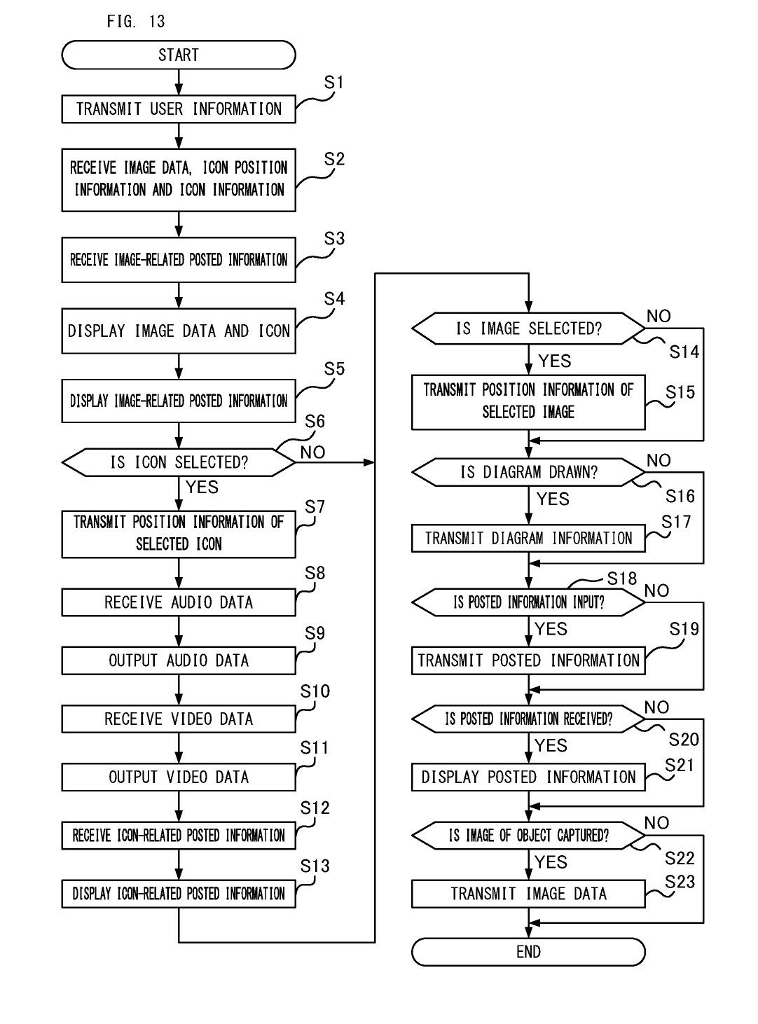

FIG. 13 is a flowchart showing a flow of processing executed by the terminal device 10.

When the user inputs an account and a password through the input unit 11, the user information transmitting unit 16 transmits the account and the password to the posted information providing device 40 via the communication I/F unit 15 (S1).

The posted information providing device 40 performs user authentication based on the account and the password, which are received from the user information transmitting unit 16, and transmits the image data, the icon position information, and the icon information to the terminal device 10 when the authentication is successful. The image data receiving unit 17 receives the image data, the icon position information, and the icon information, which are transmitted from the posted information providing device 40 via the communication I/F unit 15 (S2).

In addition, the posted information receiving unit 21 receives the image-related posted information from the posted information providing device 40 via the communication I/F unit 15 (S3).

The image data display control unit 18 performs control to display the image data, which is received by the image data receiving unit 17, on the display screen 12, and to display the icon at the position on the image data, the position being indicated by the icon position information (S4).

Moreover, the posted information display control unit 22 performs control to display the image-related posted information, which is received by the posted information receiving unit 21, on the display screen 12 (S5).

As shown in FIG. 3, the image data 60 is displayed on an upper half of the display screen 12, and the icons 61A to 61D are displayed on the image data 60. Furthermore, image-related posted information 63 is displayed on a lower half of the display screen 12.

The position information transmitting unit 20 determines whether or not the user has operated the input unit 11 to select any of the icons, which is displayed on the display screen 12, by a tap operation or the like (S6).

When the icon is selected (YES in S6), the position information transmitting unit 20 transmits the icon ID of the selected icon to the posted information providing device 40 via the communication I/F unit 15 (S7). For example, when the user has selected the icon 61B, which is shown in FIG. 3, by the tap operation or the like, the icon ID “2” of the icon 61B is transmitted to the posted information providing device 40.

The audio data receiving unit 24 receives the audio data, which corresponds to the icon ID transmitted by the position information transmitting unit 20, from the posted information providing device 40 (S8).

The audio data output unit 25 outputs the audio data, which is received by the audio data receiving unit 24, from the speaker 13 (S9).

Moreover, the video data receiving unit 27 receives the video data, which corresponds to the icon ID transmitted by the position information transmitting unit 20, from the posted information providing device 40 (S10).

The video data output unit 28 displays the video data, which is received by the video data receiving unit 27, near the icon selected by the user (S11).

The posted information receiving unit 21 receives the icon-related posted information, which corresponds to the icon ID transmitted by the position information transmitting unit 20, from the posted information providing device 40 via the communication I/F unit 15 (S12). For example, the posted information receiving unit 21 receives the icon-related posted information, which corresponds to the icon ID “2” of the icon 61B as shown in FIG. 9, from the posted information providing device 40.

The posted information display control unit 22 performs control to display the icon-related posted information, which is received by the posted information receiving unit 21, on the display screen 12 (S13). For example, as shown in FIG. 4, the icon-related posted information 62 corresponding to the icon ID “2” of the icon 61B is displayed on the display screen 12. It should be noted that, when the icon-related posted information 62 includes image data, picture data of the user's face, and the like, these data thus included may be simultaneously displayed as shown in FIG. 4.

After step S13 or when the icon is not selected (NO in S6), the position information transmitting unit 20 determines whether or not the user has selected the image data, which is displayed on the display screen 12 obtained by the user operating the input unit 11, by a tap operation or the like (S14). That is, the position information transmitting unit 20 determines whether or not the user has selected the position other than the icon on the image data by a tap operation or the like.

When the image data is selected (YES in S14), the position information transmitting unit 20 transmits the position information on the selected image data to the posted information providing device 40 via the communication I/F unit 15 (S15). By the transmission of the position information on the image data, the posted information providing device 40 will register icon position information, which indicates a correspondence relationship between the position information and the icon, and icon information in which the icon is associated with the position information. Therefore, since the posted information providing device 40 transmits the icon position information and the icon information to the terminal device 10 by subsequent processing, the terminal device 10 can display the newly registered icon on the display screen 12.

After step S15 or when no image is selected (NO in S14), the position information transmitting unit 20 determines whether or not the user has drawn a diagram on the image data (S16). That is, the position information transmitting unit 20 determines whether or not the user has operated the input unit 11 to perform a drag operation or a swipe operation on the image data.

When the diagram is drawn on the image data (YES in S16), the position information transmitting unit 20 transmits the position information of the position, which is dragged or swiped on the image data, as diagram information to the posted information providing device 40 via the communication I/F unit 15 (S17).

After step S17 or when no diagram is drawn (NO in S16), the posted information transmitting unit 23 determines whether or not the user has operated the input unit 11 to input the posted information (S18).

When the posted information is input (YES in S18), the posted information transmitting unit 23 transmits the posted information, which is input by the user, to the posted information providing device 40 via the communication I/F unit 15 (S19). For example, when the user inputs the posted information for the icon-related posted information 62 shown in FIG. 4, the input posted information is transmitted to the posted information providing device 40. Moreover, when the user inputs the posted information for the image-related posted information 63 shown in FIG. 3, the input posted information is transmitted to the posted information providing device 40.

After step S19, or when no posted information is input (NO in S18), the posted information receiving unit 21 determines whether or not new posted information is transmitted from the posted information providing device 40 and is then received (S20).

When the posted information receiving unit 21 has received such new posted information (YES in S20), the posted information display control unit 22 performs control to display the received new posted information on the display screen 12 (S21). Through such processing, information posted by another terminal device 10 can be displayed on the display screen 12.

After step S21 or when no posted information is received (NO in S20), the image data transmitting unit 26 determines whether or not the user has captured an image of an object using the camera 14 (S22).

When the user has captured the image of the object (YES in S22), the image data transmitting unit 26 receives the image data of the object from the camera 14, and transmits the received image data of the object via the communication I/F unit 15 to the posted information providing device 40 (S23). The transmitted image data will be used as an information posting target.

The terminal device 10 repeatedly executes the processing shown in FIG. 13. However, the processing of step S1 just needs to be executed only for the first time. Moreover, processing common with the previous repetition processing is appropriately omitted. For example, if the image data or the like has already been received, the processing of steps S2 and S4 is omitted. Moreover, when the icon-related posted information is displayed on the display screen 12, the processing of steps S3 and S5 is omitted.

It should be noted that, after the icon-related posted information is displayed by the user selecting the icon, for example, an operation such as pressing a hardware button provided in the terminal device 10 is performed, whereby the image-related posted information may be displayed again.

### [5. Processing Flow of Posted Information Providing Device 40]

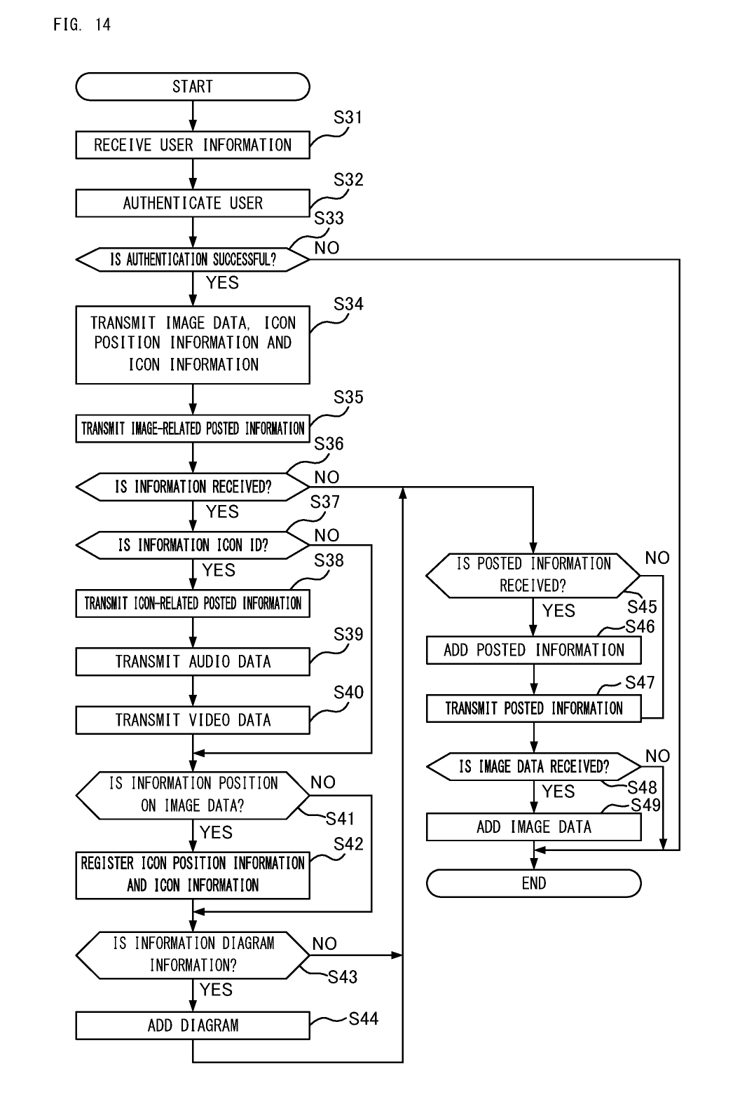

FIG. 14 is a flowchart showing a flow of processing executed by the posted information providing device 40.

The authentication unit 48 receives the user information from the terminal device 10 via the communication I/F unit 41 (S31). The user information includes information on the account and password of the user who uses the terminal device 10.

The authentication unit 48 confirms whether or not the received user information is stored in the user information storage unit 42, thereby performing authentication processing of the user (S32).

When the received user information is stored in the user information storage unit 42, and the authentication of the user is successful (YES in S33), the image data transmitting unit 50 reads the image data, the icon position information, and the icon information from the image data storage unit 43, the icon position information storage unit 44, and the icon storage unit 45, respectively, and transmits the read data to the terminal device 10 via the communication I/F unit 41 (S34).

Moreover, the posted information transmitting unit 52 reads the image-related posted information from the posted information storage unit 46, and transmits the read image-related posted information to the terminal device 10 via the communication I/F unit 41 (S35).

If the position information receiving unit 51 has received the information from the terminal device 10 via the communication I/F unit 41 (YES in S36), the position information receiving unit 51 determines whether or not the information is the icon ID stored in the icon position information storage unit 44 (S37).

If the position information receiving unit 51 has received the icon ID (YES in S37), the posted information transmitting unit 52 reads the icon-related posted information, which corresponds to the icon ID, from the posted information storage unit 46, and transmits the read icon-related posted information to the terminal device 10 via the communication I/F unit 41 (S38).

Moreover, the audio data transmitting unit 53 reads the audio data, which corresponds to the icon ID received by the position information receiving unit 51, from the audio data storage unit 47, and transmits the read audio data to the terminal device 10 via the communication I/F unit 41 (S39).

Moreover, the video data transmitting unit 56 reads the video data, which corresponds to the icon ID received by the position information receiving unit 51, from the video data storage unit 55, and transmits the read video data to the terminal device 10 via the communication I/F unit 41 (S40).

When the position information receiving unit 51 receives the information, but the received information is position information other than the icon on the image data (YES in S41), the position information receiving unit 51 associates the received position information with a new icon ID, and registers the associated position information as an icon position information in the icon position information storage unit 44, and then registers icon information in which an icon is associated with the received position information in the icon storage unit 45 (S42). The icon registered in the icon storage unit 45 is a predetermined icon.

When the position information receiving unit 51 receives the information but the received information is the diagram information (YES in S43), then according to the diagram information, the diagram adding unit 57 writes the diagram on the image data stored in the image data storage unit 43, and updates the image data storage unit 43 (S44).

After step S44, or if the position information receiving unit 51 has not received information (NO in S36), and if the posted information adding unit 54 has received the posted information from the terminal device 10 via the communication I/F unit 41 (YES in S45), the posted information adding unit 54 adds the posted information by writing the received posted information into the posted information storage unit 46 (S46).

Moreover, the posted information transmitting unit 52 reads the added posted information from the posted information storage unit 46, and transmits the posted information to the terminal device 10 being used by the user who is successfully authenticated (S47). Through such processing, in the terminal device 10, the display of the posted information is updated.

After step S47, or if the posted information has not been received (NO in S45), and if the image data receiving unit 49 has received the image data from the terminal device 10 via the communication I/F unit 41 (YES in S48), the image data receiving unit 49 adds the image data by writing the received image data into the image data storage unit 43 (S49).

The posted information providing device 40 repeatedly executes the processing shown in FIG. 14. However, the processing of step S31 just needs to be executed only at the first repetition. It should be noted that, when the user information is requested for each session of communication, the processing of step S31 just needs to be executed only at the first repetition of each session. Moreover, processing common with the previous repetition processing may be appropriately omitted. For example, if the image data or the like has already been transmitted, the processing of step S34 is omitted.

### [6. Application Example]

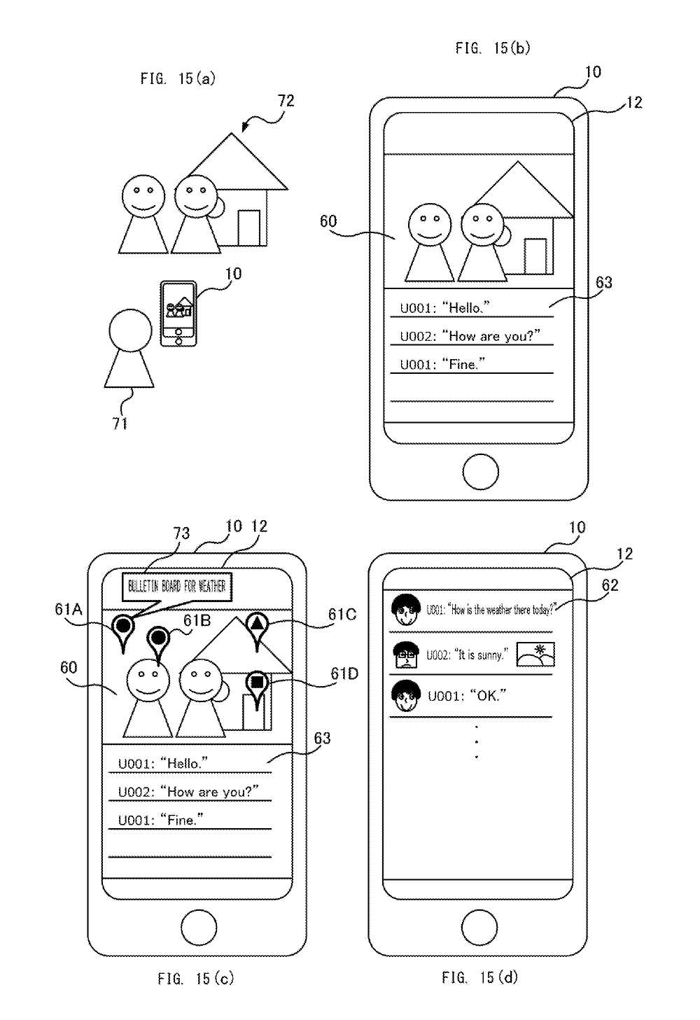

FIGS. 15(a) to 15(d) are diagrams showing an application example of the terminal device 10.

With reference to FIG. 15(a), a user 71 of the terminal device 10 captures an image of an object 72 using a camera function of the terminal device 10. Image data of the object 72 is transmitted from the terminal device 10 to the posted information providing device 40, and is distributed to the plurality of terminal devices 10.

As shown in FIG. 15(b), in each of the terminal devices 10, the image data 60 is displayed on the display screen 12. Moreover, from each terminal device 10, the image-related posted information 63 for the image data 60 can also be posted.

The user 71 selects the positions on the image data 60, whereby icons are sequentially added to the image data 60, and for example, the icons 61A to 61D are displayed as shown in FIG. 15(c). When the user selects any of the icons by a tap operation or the like, the terminal device 10 receives the audio data and the video data, which are associated with an icon ID of the selected icon, reproduces the audio data, and displays the video data near the selected icon. Moreover, the terminal device 10 receives the icon-related posted information 62, which is related to the icon ID, from the posted information providing device 40. As shown in FIG. 15(d), the terminal device 10 displays the received icon-related posted information 62 on the display screen 12. As a result, the icon-related posted information 62 for the position indicated by the icon will be displayed. Moreover, the user 71 can also post the icon-related posted information 62 for the position indicated by the icon.

Moreover, a comment can be added to the icon as shown in FIG. 15 (c). For example, near the icon 61A, a comment 73 (“bulletin board for weather”) for the icon 61A is displayed. Such a comment is posted by the user 71 in the same manner as posting the posted information, and is managed in the posted information providing device 40.

Furthermore, as shown in FIG. 15(c), display modes of the icons may be changed for each position. In other words, the icons stored in the icon storage unit 45 may have different display modes for each piece of position information. Here, although the display modes of the icon 61A and the icon 61B are the same, the display modes of the icon 61A and the icon 61B, the display mode of the icon 61C, and the display mode of the icon 61D are different from one another. The display modes of the icons may be made settable by the user 71.

### [7. Effect of Embodiments]

As described above, according to the present embodiments, the image data 60 acquired by the certain terminal device 10 of the terminal devices 10, the icon position information indicating the correspondence relationship between the position on the image data 60 and the icon ID, and the icon information in which the icon is associated with the position information are transmitted to the terminal device 10. Therefore, in the terminal device 10, the image data 60 acquired by the certain terminal device 10 of the terminal devices 10 can be displayed, and in addition, the icon can be displayed on the image data 60. Moreover, when receiving the icon ID from the terminal device 10, the posted information providing device 40 transmits, to the terminal device 10, the icon-related posted information 62 related to the icon ID. That is, when the user of the terminal device 10 designates the icon on the image data 60 by a tap operation or the like, the icon-related posted information 62 corresponding to the icon ID of the designated icon is transmitted to the terminal device 10. In the terminal device 10, the icon-related posted information 62 can be displayed. When the posted information providing device 40 receives new posting information, which is input by the user for the icon-related posted information 62, from the terminal device 10, the posted information providing device 40 can cause the posted information storage unit 46 to store the new posted information. In this way, the posted information providing device 40 can store the posted information in association with the icon ID of the icon on the image data 60 acquired by the certain terminal device 10 of the terminal devices 10, and can provide the posted information to the terminal device 10. Moreover, when receiving new posted information from the terminal device 10, the posted information providing device 40 can store the new posted information in association with the icon ID. Therefore, the user of the terminal device 10 can post information to the position indicated by the icon in the image data 60. In this way, the object for which the user is to post information is not limited to a map, and the user can post information to any image. Moreover, only by designating the icon on the image data 60, the terminal device 10 can receive the posted information related to the icon ID of the icon or can post new information. In other words, without actually going to such a place where the image data 60 is acquired, the user of the terminal device 10 can post information on the place. In this way, a function of an electronic bulletin board or chat can be provided for each position on the image data 60. As a result, the communication between the users can be activated in various fields.

Moreover, the user can post information on an arbitrary position on the image data 60 captured by the user. For example, for the image data 60 on which images of a plurality of objects are captured, if an icon associated with one of the objects is designated by a tap operation or the like, then information can be posted on the object.

Moreover, when the user of the terminal device 10 designates the position, at which no icon is disposed on the image data 60, by a tap operation or the like, the position information indicating the position is transmitted to the posted information providing device 40. With this operation, the position information of the position designated by the user is associated with the identification information of the icon, and is written as icon position information into the icon position information storage unit 44. The icon position information is written into the icon position information storage unit 44, whereby the icon information in which the icon is associated with the position information is also stored in the icon storage unit 45. In subsequent processing, the icon position information and the icon information are transmitted to the terminal device 10, whereby the user of the terminal device 10 can post new posted information corresponding to the icon ID of the icon.

Furthermore, when the user of the terminal device 10 designates the icon by a tap operation or the like, the audio data can be output from the terminal device 10. For example, in order to issue an audio instruction to each of security guards located at a concert venue, an icon is disposed on the image data 60 showing a guide map of the concert venue, and audio data corresponding to the icon is transmitted to the terminal device 10. As a result, when the security guard who uses the terminal device 10 designates such an icon corresponding to the position, at which the security guard him/herself is located, by a tap operation or the like, the security guard can be notified of an instruction by an audio message.

Furthermore, when the user of the terminal device 10 designates the icon by a tap operation or the like, the video data can also be output from the terminal device 10. As a result, for example, by a video, each user can be notified of an instruction or the like, which is difficult to convey in a sentence.

Moreover, the display mode of the icon can be changed for each position. For example, in the image data 60 obtained by capturing images of a plurality of objects, icons different for each object can be disposed. A certain icon is displayed in such a display mode of being prominent in comparison with other icons, whereby the user can be urged to browse posted information of the certain icon.

Furthermore, the posted information (image-related posted information) can be posted not only on the icon on the image data 60 but also on the entire image data 60. As a result, such a function of an electronic bulletin board or chat for exchanging information can be provided to the entire image data 60. Therefore, the communication between the users can be activated in various fields.

Specifically, each of the above devices may be configured as a computer system including a microprocessor, a ROM, a RAM, a hard disk drive, a display unit, a keyboard, a mouse and the like. A computer program is stored in the RAM or the hard disk drive. The microprocessor operates according to the computer program, whereby each of the devices achieves a function thereof. Here, in order to achieve a predetermined function, the computer program is composed by combining a plurality of instruction codes, which indicate instructions to the computer, with one another.

Moreover, some or all of the constituent elements which constitute each of the above devices may be composed of one system LSI (Large Scale Integration). The system LSI is a super multifunctional LSI manufactured by integrating a plurality of constituent parts on one chip, and specifically, is a computer system including a microprocessor, a ROM, a RAM and the like. In the RAM, a computer program is stored. The microprocessor operates according to the computer program, whereby the system LSI achieves a function thereof.

Still furthermore, some or all of the constituent elements which compose each of the above devices may be composed of an IC card or a single module, which is detachable from each device. The IC card or the module is a computer system composed of a microprocessor, a ROM, a RAM and the like. The IC card or the module may include the above super multifunctional LSI. The microprocessor operates according to the computer program, whereby the IC card or the module achieves a function thereof. The IC card or the module may have tamper resistance.

Moreover, the present invention may be the method shown above. Furthermore, the present invention may be a computer program that realizes these methods by a computer, or may be a digital signal composed of the above computer program.

Furthermore, the present invention may also be one in which the above computer program or the above digital signal is recorded in a non-transitory computer-readable recording medium, for example, such as a flexible disk, a hard disk drive, a CD-ROM, an MO, a DVD, a DVD-ROM, a DVD-RAM, a BD (Blu-ray (registered trademark) Disc) and a semiconductor memory. Moreover, the present invention may be the above digital signal recorded in such a non-transitory recording medium.

Furthermore, the present invention may be one in which the above computer program or the above digital signal is transmitted via an electric communication line, a radio or wired communication line, a network represented by the Internet, a data broadcast or the like.

Moreover, the present invention may be a computer system including a microprocessor and a memory, in which the memory stores the computer program, and the microprocessor operates according to the computer program.

Moreover, the present invention may be implemented by another independent computer system in such a manner that the above program or the above digital signal is recorded by the non-transitory recording medium, followed by transfer, or that the above program or the digital signal is transferred via the network and the like.

### [8. Appendix]

In the posted information providing device 40 described in the embodiments, essential constituent elements are the image data transmitting unit 50, the position information receiving unit 51, the posted information transmitting unit 52, and the posted information adding unit 54. Desirably, the image data storage unit 43, the icon position information storage unit 44, the posted information storage unit 46 and the icon storage unit 45 are provided in the posted information providing device 40, but may be provided outside of the posted information providing device 40. Moreover, in the terminal device 10 described in the embodiments, essential components are the image data receiving unit 17, the image data display control unit 18, the position information transmitting unit 20, the posted information receiving unit 21, the posted information display control unit 22, and the posted information transmitting unit 23.

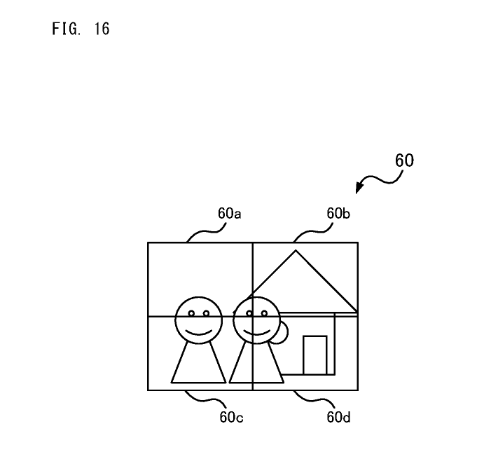

Furthermore, in the above embodiment, the description has been given of the example in which the terminal device 10 posts information on the position on the image data 60 which is one piece, but the image data 60 may include a plurality of pieces of sub image data. FIG. 16 is a diagram for describing an example of pieces of sub image data. For example, the image data 60 may be divided into four, and may include four pieces of sub image data 60a to 60d.

An example of processing executed by the terminal device 10 and the posted information providing device 40 in this case will be described below. That is, the terminal device 10 transmits the image data 60 to the posted information providing device 40. The posted information providing device 40 receives the image data 60, divides the received image data 60 into the pieces of sub image data 60a to 60d, and stores the pieces of divided sub image data 60a to 60d. A method of the division may be predetermined. The posted information providing device 40 receives the pieces of sub image data 60a to 60d and various pieces of information including posted information. The posted information providing device 40 restores the image data 60 by joining the pieces of received sub image data 60a to 60d to one another. A method of joining the pieces of sub image data 60a to 60d may be predetermined. The posted information providing device 40 performs control to display the image data 60 on the display screen 12. It should be noted that the pieces of sub image data 60a to 60d may have regions overlapping one another.

In order to realize such processing, the image data storage unit 43 of the posted information providing device 40 stores the pieces of sub image data 60a to 60d as the image data 60. It should be noted that such conversion from the image data 60 to the pieces of sub image data 60a to 60d may be performed by the image data receiving unit 49.

The posted information transmitting unit 52 of the posted information providing device 40 transmits the pieces of sub image data 60a to 60d, which are stored in the image data storage unit 43, as the image data 60 to the terminal device 10 requesting browsing of the posted information.

Similarly to the embodiments mentioned above, other processing units of the posted information providing device 40 execute processing on the image data 60. It should be noted that, since the pieces of sub image data 60a to 60d are stored in the image data storage unit 43, the respective processing units may execute the processing on the image data 60 obtained by joining the pieces of sub image data 60a to 60d to one another, or may execute the processing on each of the pieces of sub image data 60a to 60d.

The image data receiving unit 17 of the terminal device 10 receives the pieces of sub image data 60a to 60d, which are obtained by dividing the image data 60, from the posted information providing device 40.

The image data display control unit 18 of the terminal device 10 performs control to create the image data 60 by joining the pieces of sub image data 60a to 60d, which are received by the image data receiving unit 17, to one another, and to cause the display screen 12 to display the image data 60 in which the icon is superimposed on the position indicated by the position information included in the icon position information.

The terminal device 10 and the posted information providing device 40 are configured as described above, whereby the user can post the information also on image data obtained by joining a plurality of pieces of sub image data.

It should be considered that the embodiment disclosed this time is an example in all respects and is not restrictive. The scope of the present invention is indicated not by the above description but by the claims, and it is intended that all modifications within meaning and scope equivalent to the claims are included.

### INDUSTRIAL APPLICABILITY

The present invention is useful for an electronic bulletin board system, a chat system, or the like, which uses an information terminal instrument such as a personal computer, a smartphone, and a tablet.

### REFERENCE SIGNS LIST

10 terminal device

11 input unit

12 display screen

13 speaker

14 camera

15 communication I/F unit

16 user information transmitting unit

17 image data receiving unit

18 image data display control unit

20 position information transmitting unit

21 posted information receiving unit

22 posted information display control unit

23 posted information transmitting unit

24 audio data receiving unit

25 audio data output unit

26 image data transmitting unit

27 video data receiving unit

28 video data output unit

40 posted information providing device

41 communication I/F unit

42 user information storage unit

43 image data storage unit

44 icon position information storage unit

45 icon storage unit

46 posted information storage unit

47 audio data storage unit

48 authentication unit

49 image data receiving unit

50 image data transmitting unit

51 position information receiving unit

52 posted information transmitting unit

53 audio data transmitting unit

54 posted information adding unit

55 video data storage unit

56 video data transmitting unit

57 diagram adding unit

100 posted information providing system

1. A posted information providing device that is connected to a plurality of terminal devices and provides the plurality of terminal devices with posted information that is information indicating a position on one piece of image data and being posted by at least one terminal device among the plurality of terminal devices, the posted information providing device comprising:
an image data receiving unit that receives the image data from a certain terminal device of the plurality of terminal devices, the image data being acquired by the certain terminal device;
an image data storage unit that stores the image data received by the image data receiving unit;
an icon position information storage unit that stores icon position information indicating a correspondence relationship between position information indicating a position on the image data stored in the image data storage unit and identification information of an icon superimposed and displayed on the position on the image data, the position being indicated by the position information;
an icon storage unit that stores, for each piece of the position information, icon information in which the position information, one icon, and identification information of the one icon are associated with one another;
a posted information storage unit that stores the posted information in association with the identification information of the icon;
an image data transmitting unit that transmits the image data stored in the image data storage unit, the icon position information stored in the icon position information storage unit, and the icon information stored in the icon storage unit to a first terminal device that is a terminal device permitted to access the posted information providing device among the plurality of terminal devices;
a position information receiving unit that receives, from the first terminal device, the identification information of the icon designated by the first terminal device, the icon being superimposed and displayed on the image data based on the image data, the icon position information, and the icon information, which are transmitted by the image data transmitting unit;
a posted information transmitting unit that reads, from the posted information storage unit, icon-related posted information that is the posted information displayed on a display screen of the first terminal device and related to the identification information of the icon, the identification information being received by the position information receiving unit, and transmits the read icon-related posted information to the first terminal device; and
a posted information adding unit that receives new posted information for the icon-related posted information from the first terminal device, and stores the received new posted information in the posted information storage unit in association with the identification information of the icon, the identification information being received by the position information receiving unit,
wherein
the position information receiving unit receives position information indicating the position on the image data designated by the first terminal device or identification information of the icon designated by the first terminal device,
when receiving the position information, the position information receiving unit further writes the position information into the icon position information storage unit in association with the identification information of a new icon, and
the position information receiving unit associates a predetermined icon with the position information received by the position information receiving unit and registers the associated icon in the icon storage unit.

2. The posted information providing device according to claim 1, wherein the image data is image data captured by the certain terminal device of the plurality of terminal devices.

3. The posted information providing device according to claim 1, further comprising:
an audio data storage unit that stores audio data in association with the identification information of the icon; and
an audio data transmitting unit that reads, from the audio data storage unit, the audio data related to the identification information of the icon, the identification information being received by the position information receiving unit, and transmits the read audio data to the first terminal device.

4. The posted information providing device according to claim 1, further comprising:
a video data storage unit that stores video data in association with the identification information of the icon; and
a video data transmitting unit that reads, from the video data storage unit, the video data related to the identification information of the icon, the identification information being received by the position information receiving unit, and transmits the read video data to the first terminal device.

5. The posted information providing device according to claim 1, wherein the icon stored in the icon storage unit has a different display mode for each piece of the position information.

6. The posted information providing device according to claim 1, wherein
the post information storage unit further stores posted information in association with the image data,
the posted information transmitting unit further reads, from the posted information storage unit, image-related posted information that is the posted information related to the image data, and transmits the read image-related posted information to the first terminal device, and
the posted information adding unit further receives new posted information for the image-related posted information from the first terminal device, associates the received new posted information with the image data, and causes the posted information storage unit to store the associated new posted information.

7. The posted information providing device according to claim 1, wherein
the image data is data obtained by joining a plurality of pieces of sub image data to one another,
the image data storage unit stores, as the image data, the plurality of pieces of sub image data obtained by dividing the image data, and
the image data transmitting unit transmits, to the first terminal device, the plurality of pieces of sub image data stored in the image data storage unit as the image data stored in the image data storage unit.

8. A terminal device connected to a posted information providing device that provides posted information posted on a position on one piece of image data, the terminal device comprising:
a user information transmitting unit that transmits user information including an account and a password of a user of the terminal device to the posted information providing device;
an image data receiving unit that receives, from the posted information providing device, when the posted information providing device permits an access from the terminal device based on the user information transmitted by the user information transmitting unit,
the image data transmitted by a certain terminal device and received by the posted information providing device,
icon position information indicating a correspondence relationship between position information indicating the position on the image data and identification information of an icon, and
icon information in which the position information, the icon, and the identification information of the icon are associated with one another for each piece of the position information;
an image data display control unit that causes a display screen to display the image data in which the icon is superimposed on the position indicated by the position information;
a position information transmitting unit that receives an input to designate the icon and transmits the identification information of the designated icon to the posted information providing device;
a posted information receiving unit that receives, from the posted information providing device, posted information corresponding to the identification information of the icon, the identification information being transmitted by the position information transmitting unit;
a posted information display control unit that causes the display screen to display the posted information received by the posted information receiving unit; and
a posted information transmitting unit that receives new posted information for the posted information displayed on the display screen and transmits the received new posted information to the posted information providing device,
wherein
when the user of the terminal device designates a position on the image data, the position information transmitting unit further transmits position information of the designated position to the posted information providing device, and
the posted information providing device that has received the position information transmitted by the position information transmitting unit associates the identification information of a new icon with the position information and associates a predetermined icon with the position information.

9. The terminal device according to claim 8, further comprising:
an audio data receiving unit that receives, from the posted information providing device, audio data related to the identification information of the icon, the identification information being transmitted from the position information transmitting unit; and
an audio data output unit that outputs the audio data received by the audio data receiving unit.

10. The terminal device according to claim 8, wherein
the image data receiving unit receives, as the image data received by the posted information providing device, a plurality of pieces of sub image data obtained by dividing the image data, and
the image data display control unit creates the image data by joining the plurality of pieces of sub image data to one another and causes the display screen to display the image data in which the icon is superimposed at the position indicated by the position information.
